(19) United States
(12) Patent Application Publication
(10) Pub. No.: US 2026/0229005 A1
(43) Pub. Date: Aug. 6, 2026

(54) VIDEO ANALYSIS SYSTEM, VIDEO ANALYSIS METHOD, AND RECORDING MEDIUM

(71) Applicant: NEC Corporation, Tokyo (JP)

(72) Inventor: Tsuyoshi ABE, Tokyo (JP)

(73) Assignee: NEC Corporation, Tokyo (JP)

(21) Appl. No.: 19/146,254

(22) PCT Filed: Mar. 27, 2023
(86) PCT No.: PCT/JP2023/012091

§ 371 Date: Jul. 8, 2025

(51) Int. Cl. G06V 10/62; G06V 20/40; G06V 20/52; G06V 40/20

(52) U.S. Cl. CPC G06V 10/62; G06V 20/40; G06V 20/52; G06V 40/20

(57) ABSTRACT

A video analysis system includes an acquisition unit, a detection unit, an identification unit, and an output unit. The acquisition unit acquires a video of a work area. The detection unit detect movement of the object of detection from each of the frames in a time series included in the video by using a detection model. The detection model is a machine-learning model that detects movement of an object captured in frames of the video. The identification unit identifies the timing of at least one of the start of work or the end of work based on a score indicating the relationship between a reference point in the time series and the position, in the time series, of the frame in which movement of the object of detection is detected. The output unit outputs the identified timing.

### TECHNICAL FIELD

The present disclosure relates to a video analysis system and the like.

### Background Art

In a factory, for example, work in a manufacturing process is analyzed in order to improve work efficiency, improve quality, and ensure safety. The work is analyzed, for example, by analyzing a video obtained by photographing the work. The analysis result of the work is used for improving the work procedure by, for example, a manager who manages the manufacturing process. In addition, for example, in order to analyze whether a correct work is shown, a time required to perform a work defined as a work procedure may be used. The analysis of the time required to perform the work is carried out, for example, by specifying timings of the start of work and end of work based on a recognition result of the video obtained by photographing the work.

An information processing apparatus of PTL 1 specifies a procedure of work based on a video obtained by photographing the work. Then, the information processing apparatus of PTL 1 determines work omission based on the specified work procedure.

### CITATION LIST

### Patent Literature

PTL 1: JP 2019-149154 A

### SUMMARY OF INVENTION

### Technical Problem

In the technique described in PTL 1, it may be difficult to specify the timing at which the work is performed in the video obtained by photographing a work area.

In order to solve the above problems, an object of the present disclosure is to provide a video analysis system and the like capable of easily specifying a timing at which work is performed.

### Solution to Problem

In order to solve the above problem, a video analysis system according to the present disclosure includes: an acquisition means for acquiring a video obtained by photographing a work area, a detection means for detecting a motion to be detected from each of time series frames included in the video obtained by photographing the work area by using a detection model that detects a motion to be detected appearing in a frame included in the video, a specification means for specifying timing of at least one of start of work and end of work based on a score indicating a relationship between a reference point in time series and a position in time series of a frame in which the motion to be detected is detected, and an output means for outputting the specified timing.

A video analysis method according to the present disclosure includes acquiring a video obtained by photographing a work area, detecting a motion to be detected from each of time series frames included in the video obtained by photographing the work area by using a detection model that detects a motion to be detected appearing in a frame included in the video, specifying timing of at least one of start of work and end of work based on a score indicating a relationship between a reference point in time series and a position in time series of a frame in which the motion to be detected is detected, and outputting the specified timing.

A recording medium according to the present disclosure non-transiently records a video analysis program for causing a computer to execute processes of acquiring a video obtained by photographing a work area, detecting a motion to be detected from each of time series frames included in the video obtained by photographing the work area by using a detection model that detects a motion to be detected appearing in a frame included in the video, specifying timing of at least one of start of work and end of work based on a score indicating a relationship between a reference point in time series and a position in time series of a frame in which the motion to be detected is detected, and outputting the specified timing.

### Advantageous Effects of Invention

According to the present disclosure, the timing at which work is performed can be easily specified.

### BRIEF DESCRIPTION OF DRAWINGS

FIG. 1 is a diagram illustrating an example of a configuration of a video analysis system according to an example embodiment of the present disclosure.

FIG. 2 is a diagram illustrating an example of a photographing mode of a work area according to the example embodiment of the present disclosure.

FIG. 3 is a diagram illustrating an example of a work of a worker in the example embodiment of the present disclosure.

FIG. 4 is a diagram illustrating an example of a detection result by a detection model in the example embodiment of the present disclosure.

FIG. 5 is a diagram illustrating an example of a position of a frame in which a motion to be detected is detected in the example embodiment of the present disclosure.

FIG. 6 is a diagram illustrating an example of a detection result in the example embodiment of the present disclosure.

FIG. 7 is a diagram illustrating an example of an operation flow of the video analysis system according to the example embodiment of the present disclosure.

FIG. 8 is a diagram illustrating an example of a hardware configuration of the video analysis system according to the example embodiment of the present disclosure.

### EXAMPLE EMBODIMENT

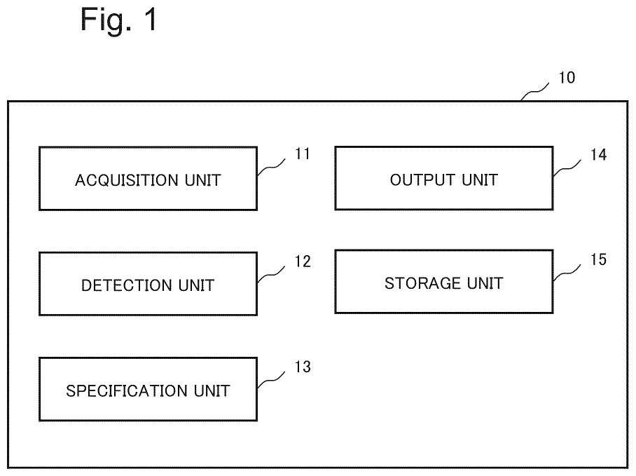

An example embodiment of the present disclosure will be described in detail with reference to the drawings. FIG. 1 is a diagram illustrating an example of a configuration of a video analysis system 10.

This video analysis system 10 includes, as a basic configuration, an acquisition unit 11, a detection unit 12, a specification unit 13, and an output unit 14. Furthermore, the video analysis system 10 includes, for example, a storage unit 15.

The video analysis system 10 is, for example, a device that analyzes work performed by a worker in a work area based on a video obtained by photographing the work area. The analysis of the work performed by the worker based on the video is carried out, for example, by analyzing whether a series of works defined in a work procedure is correctly performed by using image recognition. In the case of performing such an analysis, for example, analysis on whether the work is being performed in a correct procedure can be performed by specifying the timing at which each work is performed using image recognition. For example, when the work is correctly performed, the time required for the series of works defined in the work procedure falls within a certain range. Therefore, for example, the analysis on whether the work is being correctly performed can be performed based on the time required for the work by specifying the timings of the start of work and end of work using image recognition.

For example, the video analysis system 10 specifies a timing at which work to be analyzed is performed based on a video obtained by photographing the work area. For example, the video analysis system 10 specifies the timings of the start of work and end of work based on a video obtained by photographing the work area. Here, the timings of the start of work and end of work are timings at which frames corresponding to the start of the work and the end of the work are photographed. That is, the video analysis system 10 specifies timings of the start of work and end of work by specifying the timings at which frames corresponding to the start of the work and the end of the work are photographed.

For example, at the start or end of the work, the video analysis system 10 specifies whether the timing at which an image of any frame among images of a plurality of frames in which one same motion is shown is photographed is the timing of the start of work and end of work. The one same motion is, for example, an operation identified as performing the same operation in image recognition. For example, in a case where the timing of the start of work is specified, one same motion performed at the start of the work is shown in a plurality of frames in the video obtained by photographing the work in the work area. For example, in a case where a motion of pressing a button is performed at the start of the work, an operation in which it is identified that the worker is pressing the button in the image recognition is shown in a plurality of frames as the timing of touching the button and the timing of pressing the button. The video analysis system 10 specifies whether the timing at which an image of any frame among a plurality of frames in which one same motion is shown is photographed is the timing at which work has started.

In addition, the work area is, for example, an area in which one or a plurality of workers perform a defined work in a factory. The defined work is, for example, work designated in the work procedure. In the work procedure, for example, a name of a product to be worked, a member to be used, a tool to be used, and a work order are designated. A combination of a plurality of works whose order is designated in the work procedure is also referred to as a work flow. The items designated in the work procedure are not limited to the above. The work procedure is created, for example, by a production engineer or a manager of the manufacturing process.

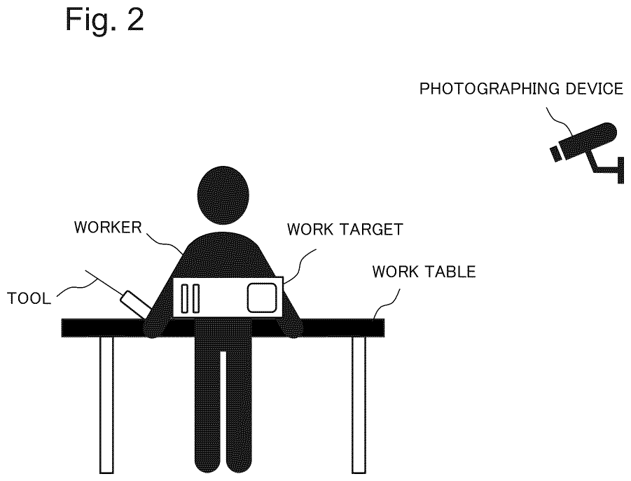

FIG. 2 illustrates an example of a photographing mode of work performed in the work area. In the example of FIG. 2, the worker stands at a position where the worker can perform work on a product placed on a work table. Furthermore, in the example of FIG. 2, the worker performs an assembling work of the product to be worked placed on the work table by using, for example, a tool held in the hand. In the example of FIG. 2, for example, the worker performs the work according to a work procedure. In addition, in the example of FIG. 2, a photographing device that photographs the work table and the worker is installed. In this case, the work area is, for example, a place on the work table and a place where the worker is standing. The place where the worker is standing includes a range in which the worker can move during work. The photographing device outputs the photographed image to the video analysis system 10 via, for example, a network. For example, the video analysis system 10 specifies the timings of the start of work and end of work based on a video obtained by photographing the work area by the photographing device.

Here, a specific example of the configuration of the video analysis system 10 will be described.

The acquisition unit 11 acquires a video obtained by photographing a work area. In addition, the video obtained by photographing the work area is, for example, a video obtained by photographing the motion of the worker from the start to the end of the work performed by the worker. The work performed by the worker is, for example, work related to manufacturing of a product. The work related to manufacturing of a product includes, for example, assembly of a product, processing of a product, inspection of a product, packaging of a product, conveyance of a product, operation of facility, or organization of a storage shelf, and the work related to manufacturing of a product, the work performed by the worker may be inspection of the facility, repair of the facility, or assembly of the facility. The work related to the manufacturing of a product may also include cooking of a food product. The work related to manufacturing of the product is not limited to the above. In addition, the work performed by the worker may be cleaning, driving, exercising, guidance to others, guiding, security, medical practice, dispensing work, and operation of equipment. The work performed by the worker is not limited to the above.

For example, the acquisition unit 11 acquires, from a photographing device installed at a position where a work area can be photographed, a video obtained by photographing the work area by the photographing device. When there is a monitoring system that monitor a manufacturing process, the acquisition unit 11 may acquire a video obtained by photographing the work area via a server of the monitoring system. In addition, the acquisition unit 11 may acquire a video obtained by photographing the work area via a recording medium.

The detection unit 12 uses a detection model that detects the motion to be detected appearing in the frame included in the video, and the detection model that detects the motion to be detected from each of the time-series frames included in the video obtained by photographing the work area is a learning model that identifies the work appearing in each of the time-series frames included in the video by using the image recognition technique. For example, the detection model identifies whether the motion to be detected is shown in each frame.

The motion to be detected is, for example, an operation related to work performed at the start and the end among a plurality of works included in the work flow. For example, in a case where it is defined in the work procedure that the first work is to hold a tool, the detection model detects a motion in which the worker holds the tool performed as the starting work. For example, in a case where it is defined in the work procedure that the last work is to place a tool, the detection model detects a motion in which the worker places the tool performed as the ending work. The starting and ending works may be, for example, works related to reporting of the start and end of the work. For example, when the worker reports the start and end of the work by pressing a report button, the detection model detects a motion in which the worker presses the report button. In addition, the motion to be detected may be motions at the start and end in each work included in the work flow. Furthermore, the motion to be detected may be motions at the start and end of some works of the works included in the work flow. For example, the motion to be detected may be the motion of the start of the first work and the motion of the end of the last work of three continuously performed works among ten works included in the work flow. The motion to be detected is not limited to the above.

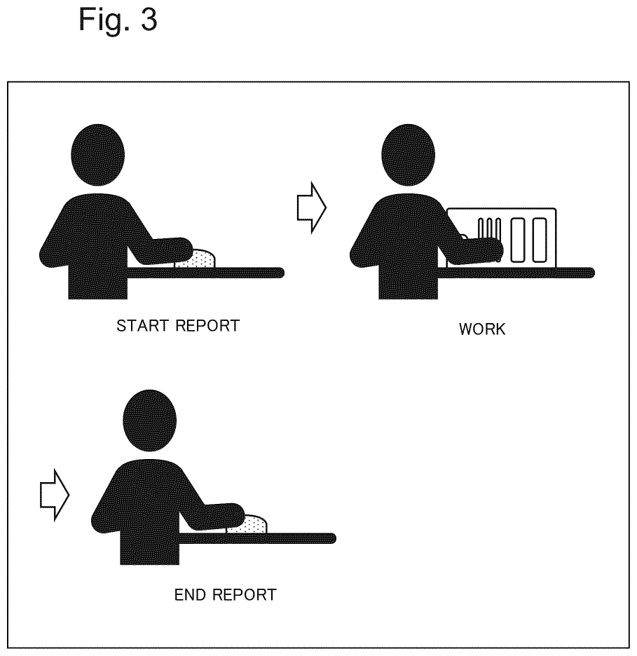

FIG. 3 illustrates an example of a work performed by a worker according to a work procedure. “Start report” in the example of FIG. 3 indicates work in which the worker presses a report button at the start of the work flow. “Work” in the example of FIG. 3 indicates, for example, a state in which a worker is performing work according to a work procedure. “End report” in the example of FIG. 3 indicates work in which the worker presses a report button at the end of the work flow.

When the worker presses the report button in the “start report” in the example of FIG. 3, the motion in which the worker presses the button appears in a plurality of frames. The detection model detects, for example, a motion of pressing a button from an image of each frame in which the work of the worker pressing the button is shown in a video obtained by photographing the work area.

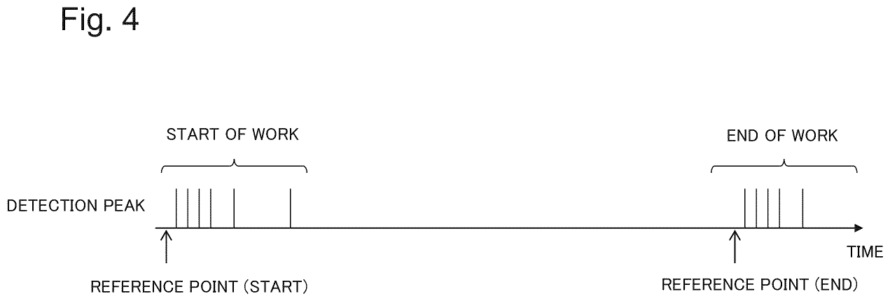

FIG. 4 illustrates an example of a detection result of the motion in which the worker presses the button by the detection model. In the example of the detection result of FIG. 4, the horizontal axis represents time. In addition, in the example of the detection result of FIG. 4, a line in a vertical direction indicated as a detection peak indicates that the motion of pressing the button has been detected by the detection model in the frame corresponding to each time in time series. The example of the detection result of FIG. 4 illustrates an example in which, for example, in a case where the certainty factor of the identification by the detection model exceeds the reference, the detection is performed as the motion of pressing the button. The detection result by the detection model may be a value of certainty factor of identification. In the example of the detection result of FIG. 4, the reference point (start) and the reference point (end) indicate time points serving as a reference when specifying the timings of the start of work and end of work. The reference point will be described later. In the example of the detection result of FIG. 4, the work of pressing the button is detected from the images of the plurality of frames included in each of the time zone in which the button is pressed at the start of the work and the time zone in which the button is pressed at the end of the work. As described above, the detection model detects one same motion from each of the images of the plurality of frames.

For example, in a case where the detection model detects the motion of pressing the report button in a state where no work is performed, the detection unit 12 detects the motion of pressing the button detected by the detection model as the starting work. In addition, for example, in a case where the reporting at the start and the end is performed using the same button, the detection unit 12 detects, when detecting the motion of pressing the button after elapse of a time set after the detection of the start of the work, the detected motion of pressing the button as the ending work. The elapsed time from the start for specifying as the end is set, for example, based on a standard working time by a person who analyzes the work.

The detection model is, for example, a machine learning model using a neural network. The detection model is generated, for example, by learning a relationship between an image showing the motion to be detected, and a region showing the motion to be detected and a type of the motion to be detected. The detection model is generated, for example, in a system external to the video analysis system 10.

The detection unit 12 may detect the starting work and the ending by work by using a plurality of detection models. The detection unit 12 specifies the position of the hand of the worker in the image of the frame by using, for example, a detection model that detects the position of the body of the worker from the video. In addition, the detection unit 12 detects the tool held by the worker by using the detection model that detects the type of the tool at the specified position. Then, the detection unit 12 detects the start of the work, for example, in a case where the hand of the worker is at the placement location of the tool and the held tool is a tool determined to be used in the first work of the work flow.

In addition, the detection unit 12 detects the end of the work, for example, in a case where the position of the hand of the worker is at the placement location of the tool after the work is started and there is a tool determined to be used in the last work of the work flow. Furthermore, the detection unit 12 may detect the starting work and the ending work using different detection models. Moreover, the detection unit 12 may detect the motion of the work and the motion of the work by using a detection model different for each work included in the work flow.

The detection unit 12 may detect at least one of clothes and an attachment of the worker by using the detection model. The detection unit 12 may detect the position where the worker is standing by using the detection model. In addition, the detection unit 12 may detect the position where the worker is sitting by using the detection model. Furthermore, the detection unit 12 may detect the posture of the worker by using the detection model. In addition, the detection unit 12 may detect the number of workers in the work area by using the detection model. In addition, the detection unit 12 may detect turning on and off of a lamp indicating that work is being performed by using the detection model. The detection target by the detection model is not limited to the above.

For example, the specification unit 13 specifies the most probable frame as a frame photographed at each timing of the start of the work and the start of the work from a plurality of frames in which the detection model has detected the motion to be detected. Then, the specification unit 13 specifies that the timings at which the specified frame is photographed are timings of the start of the work and the end of the work. For example, the specification unit 13 specifies a frame photographed at the most probable position in time series among the frames detected by the detection model as a frame photographed at each timing of the start of work and end of work. The specification unit 13 specifies the timing of at least one of the start of work and the end of work based on a score indicating the relationship between a reference point in time series and the position, in time series, of the frame in which motion to be detected is detected. In addition, the specification unit 13 specifies the timing of at least one of the start of work and the end of work based on, for example, the score indicating the relationship between the reference point and the position of the frame and the certainty factor of the detection of the motion to be detected by the detection model.

For example, the specification unit 13 specifies the timings of the start of work and end of work with the timing closer to the reference point set in time series as being more likely to be the timings of the start of work and end of work. The reference point is a time point in time series serving as a reference for calculating the score. For example, in a case where the reference point is set at a time point when the work is not performed, a frame photographed at a time point close to the reference point has a higher possibility of being more appropriate as a frame for starting the work. Therefore, for example, the specification unit 13 specifies the timings of the start of work and end of work based on the reference point in time series and the position where the frame is photographed. For example, the specification unit 13 calculates a score indicating the relationship between the reference point in time series and the position of the frame in which the motion to be detected is detected for each frame in which the motion to be detected is detected. For example, the specification unit 13 calculates the score indicating the relationship between the reference point and the position of the frame such that the value becomes smaller as the position of the frame becomes farther away from the reference point. The specification unit 13 determines a frame having the highest calculated score. Then, the specification unit 13 specifies that the timing at which the frame having the highest calculated score is photographed is the timing of the start of work or end of work.

The score indicating the relationship between the reference point and the position in time series where the frame in which the motion to be detected is detected is photographed is calculated based on, for example, the time difference between the reference point and the time point at which the frame is photographed. For example, the specification unit 13 calculates the score based on the time difference between the time point at which the image of the frame is photographed and the time point of the reference point.. For example, the specification unit 13 calculates the score such that the value becomes smaller as the time difference between the time point at which the frame for which the score is to be calculated is photographed and the time point of the reference point increases. For example, the specification unit 13 may calculate the score based on the number of frames between the frame for which the score is to be calculated and the reference point. For example, the specification unit 13 calculates the score such that the value becomes smaller as the number of frames between the frame for which the score is to be calculated and the reference point increases. Furthermore, the specification unit 13 may calculate the score based on the order in time series of the frames in which the motion to be detected is detected after the reference point.

For example, the specification unit 13 calculates the score such that the value becomes smaller as the number indicating the order in time series of the frames in which the motion to be detected is detected increases.

For example, the specification unit 13 may determine each timing of the start of work and the end of work with a frame closer to the center in time series among the frames in which the detection model has detected the motion to be detected as being more likely to be a frame photographed at each timing of the start of work and end of work. For example, in the case of the motion of pressing the button, the motion from when the hand touches the button to when the button is pressed and the hand is released from the button is detected as the same motion. In such a motion of pressing the button, there is a case where a frame photographed at a timing near the center is more likely to be the timing of the start of work or end of work. In this case, for example, the specification unit 13 calculates the score indicating the relationship between the reference point and the position of the frame in such a way that the value becomes larger for the frame closer to the center in time series among the frames in which the motion to be detected is detected within a predetermined time from the reference point. As a specific example, for example, in a case where a frame to be detected is detected in images of nine frames within a predetermined time, the specification unit 13 calculates the score indicating the relationship between the reference point and the position of the frame such that the score of the fifth frame at the center is the highest. Furthermore, for example, in a case where there are a plurality of frames having the same score because the total number of frames is an even number, the specification unit 13 specifies the timing of the frame close to the reference point as the timing of the start of work or end of work. The predetermined time is set by a person who analyzes the work based on, for example, a time when the start of the work and the end of the work are assumed to appear in the images of the frames. Furthermore, the specification unit 13 may specify a frame close to the center in time series based on the time when each image of the frame has been photographed.

In a case where, among the frames in which the same work has been detected, a position in time series of the frame most likely as the timings of the start of work and end of work can be assumed, the specification unit 13 may calculate the score such that the score of a frame at a predetermined position in time series from the reference point becomes higher. For example, the specification unit 13 calculates the score such that the value becomes larger in a frame in which the order in time series of the frames in which the motion to be detected is detected is a predetermined order. In this case, for example, the specification unit 13 calculates the score such that the value becomes smaller as the order in time series of the frames for which the score is calculated deviates from the predetermined order. In addition, the specification unit 13 may calculate the score such that the value becomes larger at a position away from the time point of the reference point by a predetermined time. In this case, for example, the specification unit 13 calculates the score such that the value becomes larger as the position in time series of the frame for which the score is calculated becomes closer to a position away from the time point of the reference point by a predetermined time. For example, in a case where the work of pressing the button is detected, it is assumed appropriate to detect the timing at which the button is actually pressed as the timing of the start or end of work rather than the timing at which the button is touched. At this time, for example, in a case where the button is pressed after waiting for the target product of the work to be automatically set, the timing at which the button is pressed may be assumed. In such a case, the specification unit 13 can more appropriately specify the timing at which the motion to be detected is performed by making the score higher the closer it is to a predetermined position in time series assumed from the work content. The predetermined time used for calculating the score is set based on the content of the motion to be detected, for example, by a person who analyzes the work.

In time series, frames in which the detection model has detected the motion to be detected can be densely arranged near the time point at which the motion to be detected has been performed. In such a case, for example, the specification unit 13 calculates the score such that the score of the frame to be calculated becomes higher as the number of frames in which the certainty factor of the detection of the motion to be detected is equal to or greater than the reference value increases within a range of a predetermined number of frames from the frame for which the score is to be calculated. For example, the specification unit 13 calculates a score indicating the relationship between the reference point and the position of the frame based on the number of frames in which the motion to be detected is detected in the frames before and after, in time series, the frame to be calculated. For example, the specification unit 13 performs the calculation based on the number of frames in which the motion to be detected is detected within a predetermined number of frames before and after, in time series, the frame to be calculated.

For example, the specification unit 13 calculates the score such that the value becomes larger as the number of frames in which the motion to be detected is detected increases within a predetermined number of frames before and after, in time series, the frame to be calculated. For example, in a case where the predetermined number of frames is set to three, the specification unit 13 calculates the score such that the value becomes larger as the number of frames in which the motion to be detected is detected increases in the preceding and following three frames, in time series, from the frame to be calculated.

The specification unit 13 may specify the timings of the start and end of work by using the score of the frame for which the score is to be calculated and the scores of the frames within a predetermined number of frames in time series from the frame for which the score is to be calculated. For example, the specification unit 13 may calculate a score indicating the relationship between the reference point and the position of the frame as an average value of the frames within a predetermined number of preceding and following frames in time series from the frame to be calculated. At the timing the motion to be detected is performed, frames in which the motion to be detected is shown can be continuously detected in time series. Therefore, the specific accuracy of timings of the start of work and end of work can be improved by reflecting the detection situation of the motion to be detected in the frame in the vicinity of, in times series, the frame for which the score is to be calculated on the score. In addition, the reference for calculating the score is not limited to the above.

For example, the specification unit 13 sets, as the reference point, a frame in which the detection unit 12 has started the process of detecting the motion to be detected among the time series frames included in the video obtained by photographing the work area. The specification unit 13 may set, as a reference point for specifying the timing to end the work, a time point at which a predetermined time has elapsed from the timing the work started among time series frames included in the video obtained by photographing the work area. The predetermined time from the timing the work started is set by a person who analyzes the work based on, for example, the time required for the work. Furthermore, the reference point may be set using data of the production management system. For example, the specification unit 13 sets, as a reference point, a time point in the video corresponding to the time to start the work and end the work recorded in the production management system. In addition, the reference point can be appropriately set according to the analysis content and the analysis target.

In a case where the work to be analyzed is a work in which the same work is repeatedly performed, the specification unit 13 may set the reference point for detecting the start of each repeatedly performed work to the timing at which the previous work ends. In addition, in a case where the start of the repeatedly performed work is detected, the specification unit 13 may set, as a reference point, a time point at which a predetermined time has elapsed from the timing of the start or end of the previous work. The predetermined time may be set based on the number of frames. The predetermined time from the timing of the start or end of the previous work is set by a person who analyzes the work based on, for example, the time required for one work.

Furthermore, in a case where the timings of the start and end of work are determined based on the score and the certainty factor, the certainty factor of the detection of the motion to be detected is, for example, an index indicating the certainty of the determination of the motion to be detected by the detection model. The certainty factor of detection of the motion to be detected is, for example, a probability that the motion shown in the image of the frame is the motion to be detected calculated by the detection model. For example, in a case where the probability is equal to or greater than a reference, the detection model specifies that the motion shown in the image of the frame is the motion to be detected. The reference for specifying that the motion shown in the image of the frame is the motion to be detected is set by, for example, a person who generates the detection model.

The specification unit 13 may specify each timing of the start of work and the end of work by using the position of the frame in time series and the certainty factor of the detection by the detection model. For example, the timings of the start of work and the end of work can be specified more accurately by using both the certainty of the position in time series of the frame in which the motion to be detected has been detected and the certainty of the detection by the detection model. For example, the specification unit 13 specifies the timings of the start of work and the end of work based on a score indicating the relationship between the reference point and the position of the frame and an index calculated from the certainty factor of detection of the motion to be detected by the detection model. For example, the specification unit 13 specifies the timings of the start of work and the end of work based on an index calculated by a product of the score indicating the relationship between the reference point and the position of the frame and the certainty factor of detection of the motion to be detected by the detection model.

Here, it is assumed that a position score that is a score indicating the relationship between the reference point and the position of the frame is Sp. In addition, it is assumed that the certainty factor of the detection of the motion to be detected is P. Furthermore, it is assumed that an index calculated from a position score that is a score indicating the relationship between the reference point and the position of the frame and a certainty factor of detection of the motion to be detected by the detection model is a total score St. At this time, the specification unit 13 calculates the total score St using, for example, a formula of St =Sp x P. Then, the specification unit 13 specifies the timings of the start of work and the end of work assuming that the frame having the largest value of the total score St among the frames in which the motion to be detected has been detected is the frame of the start of work and the end of work.

The specification unit 13 may calculate the total score St based on the detected clothes and attachments of the worker and specify the timings of the start of work and the end of work. For example, in a case where at least one of the clothes of the worker is the clothes and the attachments of when the attachments perform the work, the specification unit 13 calculates the total score St in such a way that the value becomes large. In addition, the specification unit 13 may calculate the total score St in such a way that the value becomes larger when the position where the worker is standing or sitting is a place determined as a place where work is performed. In addition, the specification unit 13 may calculate the total score St in such a way that the value becomes higher when the number of workers in the work area matches the number of workers performing the work. Then, the specification unit 13 specifies the timings of the start of work and the end of work assuming that the frame in which the value of the calculated total score St is the largest is the frame of the start of work and the end of work.

In a case where turning on and off of the lamp indicating that the work is being performed is detected by the detection model, the specification unit 13 may calculate the total score St in such a way that the value of the frame in which the lamp is turned on becomes high. For example, when specifying the timing of the start of work, the specification unit 13 calculates the total score St in such a way that the value of the frame in which the lamp that was turned off in the previous frame is turned on increases in time series. In addition, for example, when specifying the timing of the end of work, the specification unit 13 calculates the total score St in such a way that the value of the frame in which the lamp that has been turned on is turned off in the next frame increases in time series.

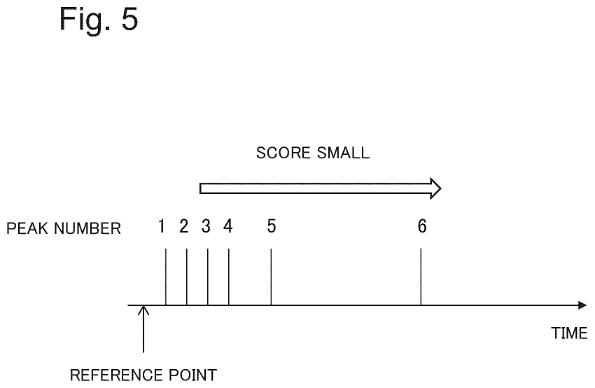

FIG. 5 illustrates an example of a position in time series of a frame in which the motion to be detected has been detected among the plurality of frames in time series. In the example of FIG. 5, the horizontal axis represents time. Furthermore, in the example of FIG. 5, a peak indicated by a line in a vertical direction indicates that the motion to be detected has been detected by the detection model in the frame corresponding to each time in time series. In the example of FIG. 5, a peak number is added to distinguish a peak indicating that the motion to be detected has been detected. In the example of FIG. 5, since the position from the reference point is farther as the peak number increases, the score indicating the relationship between the reference point and the position of the frame becomes smaller.

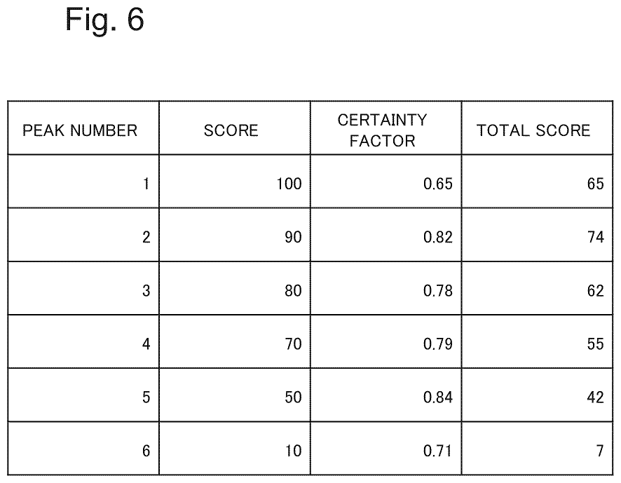

FIG. 6 illustrates an example of the total score of each frame in a case where the motion to be detected is detected from the image of the frame at the position in time series illustrated in the example of FIG. 5. The peak number in the example of FIG. 6 corresponds to the peak number in the example of FIG. 5. In the example of FIG. 6, the score, the certainty factor, and the total score of the frame corresponding to each peak number are illustrated. In the example of FIG. 6, the score of the frame with peak number 1 closest to the reference point is the highest. In the example of FIG. 6, for the certainty factor, the certainty factor of the frame with peak number 2 is the highest. Furthermore, in the example of FIG. 6, the total score that is the product of the score and the certainty factor is the highest in the frame with peak number 2. Therefore, the specification unit 13 specifies the timing at which the frame with peak number 2 is photographed as the timing of the start or end of work.

The specification unit 13 may weigh at least one of the position score and the certainty factor of the detection by the detection model to specify the timing of the start of work and the end of work. For example, the specification unit 13 weights at least one of the position score and the certainty factor of the detection by the detection model to calculate the total score. In addition, the specification unit 13 may calculate the total score of the target frame by using the statistical values of the preceding and following frames of the target frame.

The output unit 14 outputs the timing specified by the specification unit 13. The output unit 14 outputs, for example, the timing of at least one of the start of work and the end of work specified by the specification unit 13 to a terminal device operated by a person who analyzes the work. The output unit 14 may output a video recording the timing of the start and end of work. The output unit 14 may output the timing specified by the specification unit 13 to a display device (not illustrated) connected to the video analysis system. The output unit 14 may output a video between the timings of the start and end of work among videos obtained by photographing the work area. In addition, the output unit 14 may output the work time calculated from the timings of the start of work and the end of work. In addition, the output unit 14 may output the image of the frame specified as the timings of the start and end of work and the information indicating that the image is the image of the frame specified as the timings of the start and end of the work together with the images of the preceding and following frames in time series.

The storage unit 15 saves, for example, a video obtained by photographing the work area. In addition, the storage unit 15 saves the detection model. The detection model may be saved in storage means outside the video analysis system 10. The storage unit 15 saves, for example, specification results of the timings of the start and end of work. The storage unit 15 may save a video between the timings of the start and end of work among videos obtained by photographing the work area. The storage unit 15 may save images of the frames specified as timings of the start and end of work and images of preceding and following frames in time series.

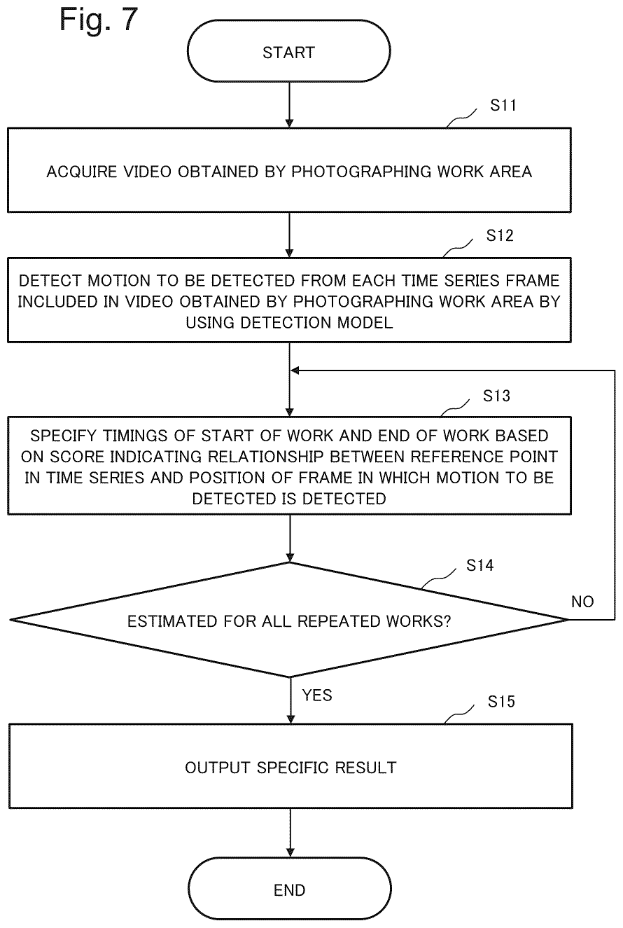

An operation in which the video analysis system 10 specifies the timings of the start of work and the start of work will be described. FIG. 7 illustrates an example of an operation flow when the video analysis system 10 specifies the timings of the start of work and the start of work.

The acquisition unit 11 acquires a video obtained by photographing the work area (step S11). For example, the acquisition unit 11 acquires a video obtained by the photographing device photographing the work area from the photographing device installed in such a way as to be able to photograph the work area.

When the video obtained by photographing the work area is acquired, the detection unit 12 detects the motion to be detected from each of the time series frames included in the video obtained by photographing the work area by using the detection model that detects the motion to be detected appearing in the frame included in the video (step S12).

The specification unit 13 specifies the timings of the start of work and the end of work based on a score indicating the relationship between a reference point in time series and the position of the frame in which motion to be detected is detected (step S13). The specification unit 13 may specify the timing of at least one of the start of work and the end of work based on a score indicating the relationship between a reference point in time series and the position of the frame in which motion to be detected is detected.

In a case where the specification of the timings of the start of work and the end of work has finished for all the repeatedly performed works in step S13 (Yes in step S14), the output unit 14 outputs the timings of the start of work and the end of work specified by the specification unit 13 (step S15).

In a case where the specification of the timings of the start of work and the end of work has not finished for all the repeatedly performed works in step S13 (No in step S15), the process returns to step S13, and the specification unit 13 specifies the timing of at least one of the start of work and the end of work based on the score indicating the relationship between the reference point in time series and the position of the frame in which the motion to be detected has been detected.

The video analysis system 10 detects the motion to be detected from each of time series frames included in the image obtained by photographing the work area by using the detection model. The motion to be detected is, for example, a motion performed at the start and end of the work. The video analysis system 10 specifies the timings of the start of work and the end of work based on the score indicating the relationship between the reference point in time series and the position of the frame in which the motion to be detected is detected. In this way, the timings of the start of work and the end of work can be easily specified by using the video analysis system 10.

In addition, the video analysis system 10 specifies the timings of the start and end of work based on the certainty factor of the detection of the detection model and the score relating to the position of the frame in which the motion to be detected has been detected, in such a way that the timings of the start and end of work can be specified by using the certainty specified by the detection model and the certainty based on the position of the frame. Therefore, in a case where the certainty factor of detection of the detection model and the score relating to the position of the frame in which the motion to be detected has been detected are used to specify the timings of the start and end of work, the video analysis system 10 can more accurately specify the timings of the start of work and the end of work.

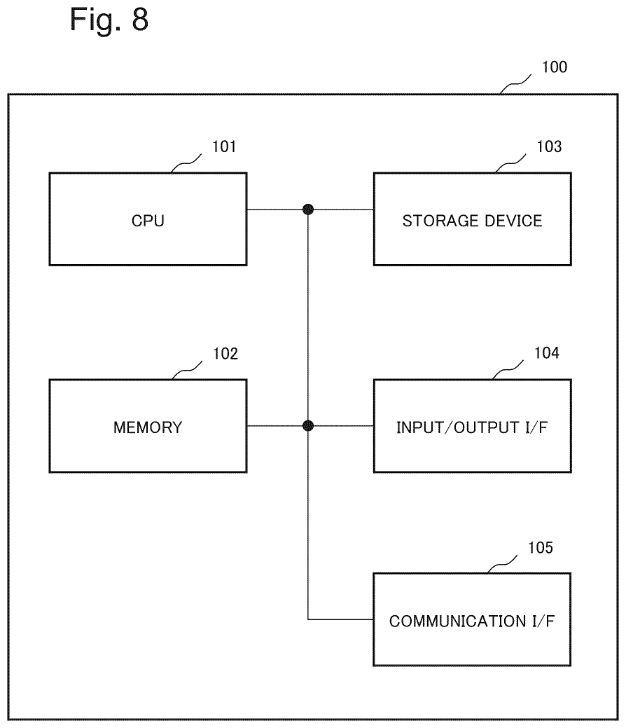

Each process in the video analysis system 10 can be implemented by executing a computer program on a computer. FIG. 8 illustrates an example of a configuration of a computer 100 that executes a computer program for executing each process in the video analysis system 10. The computer 100 includes a central processing unit (CPU) 101, a memory 102, a storage device 103, an input/output interface (I/F) 104, and a communication I/F 105.

The CPU 101 reads and executes a computer program for executing each process from the storage device 103. The CPU 101 may be configured by a combination of a plurality of CPUs. Furthermore, the CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. The storage device 103 may include another storage device such as a hard disk drive. The input/output I/F 104 is an interface for receiving an input from a worker and outputting display data and the like. The communication I/F 105 is an interface for transmitting and receiving data to and from another information processing apparatus.

The computer program used for executing each processing can also be distributed by being stored in a computer-readable recording medium that non-transiently records data. The recording medium can include, for example, a magnetic tape for data recording or a magnetic disk such as a hard disk. The recording medium may include an optical disk such as a compact disc read only memory (CD-ROM). A non-volatile semiconductor storage device may be used as a recording medium.

The present disclosure has been particularly shown and described by taking the above-described example embodiment as an example. However, the present disclosure is not limited to the above-described example embodiments. That is, it will be understood by those of ordinary skill in the art that the present disclosure can apply various aspects without departing from the spirit and the scope of the present disclosure as defined by the claims.

### REFERENCE SIGNS LIST

10 video analysis system
11 acquisition unit
12 detection unit
13 specification unit
14 output unit
15 storage unit
100 computer
101 CPU
102 memory
103 storage device
104 input/output I/F
105 communication I/F

What is claimed is:

1. A video analysis system comprising:
at least one memory storing instructions; and
at least one processor configured to access the at least one memory and execute the instructions to:
acquire a video obtained by photographing a work area;
detect a motion to be detected from each of time series frames included in the video obtained by photographing the work area by using a detection model that detects a motion to be detected appearing in a frame included in the video;
specify timing of at least one of start of work and end of work based on a score indicating a relationship between a reference point in time series and a position in time series of a frame in which the motion to be detected is detected; and
output the specified timing.

2. The video analysis system according to claim 1, wherein
the at least one processor is further configured to execute the instructions to:
specify the timing based on the score and a certainty factor of detection of the motion to be detected by the detection model.

3. The video analysis system according to claim 2, wherein
the at least one processor is further configured to execute the instructions to:
specify the timing based on an index calculated by a product of the score and the certainty factor.

4. The video analysis system according to claim 2, wherein,
the at least one processor is further configured to execute the instructions to:
calculate the score such that a score of a frame to be calculated becomes higher as the number of frames in which the certainty factor of the detection of the motion to be detected is equal to or greater than a reference value increases within a range of a predetermined number of frames from the frame for which a score is to be calculated.

5. The video analysis system according to claim 1, wherein
the at least one processor is further configured to execute the instructions to:
specify the timing by using a score of the frame for which a score is to be calculated and scores of the frames within a predetermined number of frames in time series from the frame to be calculated.

6. The video analysis system according to claim 1, wherein
a value of the score becomes smaller as the position of the frame becomes farther from the reference point.

7. The video analysis system according to claim 1. wherein
the score is a score based on an order in time series of the frames in which the motion to be detected is detected after the reference point.

8. The video analysis system according to claim 1, wherein
the score is a score based on an elapsed time from the reference point to a frame in which the motion to be detected is detected or the number of frames in time series.

9. A video analysis method comprising:
acquiring a video obtained by photographing a work area;
detecting a motion to be detected from each of time series frames included in the video obtained by photographing the work area by using a detection model that detects a motion to be detected appearing in a frame included in the video;
specifying timing of at least one of start of work and end of work based on a score indicating a relationship between a reference point in time series and a position in time series of a frame in which the motion to be detected is detected; and
outputting the specified timing.

10. A non-transitory recording medium that non transiently records a video analysis program for causing a computer to execute processes of:
acquiring a video obtained by photographing a work area;
detecting a motion to be detected from each of time series frames included in the video obtained by photographing the work area by using a detection model that detects a motion to be detected appearing in a frame included in the video;
specifying timing of at least one of start of work and end of work based on a score indicating a relationship between a reference point in time series and a position in time series of a frame in which the motion to be detected is detected; and
outputting the specified timing.
